(19) United States
(12) Patent Application Publication
(10) Pub. No.: US 2026/0359812 A1
(43) Pub. Date: Nov. 12, 2026

(54) NETWORK MESSAGING STATE MANAGEMENT

(71) Applicant: MASTERCARD INTERNATIONAL INCORPORATED, Purchase, NY (US)

(72) Inventors: Balamurali BALASUBRAMANIAN, Puzhuthivakkam Chennai (IN); Pallavi KAKDE, Pimple Saudagar (IN)

(73) Assignee: MASTERCARD INTERNATIONAL INCORPORATED, Purchase, NY (US)

(21) Appl. No.: 19/204,512

(22) Filed: May 10, 2025

(51) Int. Cl. G06Q 20/38; G06Q 20/40; H04L 45/00; H04L 51/10; H04L 51/234

(52) U.S. Cl. CPC G06Q 20/386; G06Q 20/40; H04L 45/38; H04L 51/10; H04L 51/234

(57) ABSTRACT

A process may include receiving a first network message that is associated with a first network message flow of a first transaction and that includes first information, that information includes first information includes a first identifier. The process may include determining, using derivation logic and at least a portion of the first information, a first network message state of the first network message. The process may include routing the first network message to a destination computing device and storing a first record that includes the first identifier, the first network message state, and at least a portion of the first information in a storage device.

### BACKGROUND

### Technical Field

The present disclosure generally relates to systems and methods for use in facilitating network messaging, and in particular to systems and methods for determining a state of a network message in a network messaging flow.

### Description of Related Art

Credit card processing technology plays a critical role in modern financial transactions, enabling seamless and secure electronic payments across various industries. However, the complexity of processing a credit card transaction involves multiple entities, including the cardholder, merchant, acquiring bank, issuing bank, and payment networks. One of the key challenges in credit card processing is ensuring the security and integrity of transactions while maintaining high-speed authorization, clearing, and settlement. Fraud prevention, regulatory compliance, and interoperability between different financial institutions further complicate the process. Additionally, credit card processing must efficiently handle large transaction volumes while minimizing latency and errors that could disrupt commerce.

A typical credit card transaction involves three primary stages: authorization, clearing, and settlement. During authorization, when a cardholder initiates a purchase, the merchant's point-of-sale (POS) system or online payment gateway transmits the transaction details to the acquiring bank, which then forwards the request to the payment/card network (e.g., Mastercard). The card network communicates with the issuing bank, which verifies the cardholder's account, checks for sufficient funds or credit limit, and assesses the transaction for potential fraud. If approved, the issuing bank sends an authorization code back through the payment network to the acquiring bank and ultimately to the merchant, allowing the transaction to proceed.

Clearing occurs after authorization when the merchant submits the approved transactions in batches to the acquiring bank for processing. The acquiring bank forwards these transactions to the payment network, which coordinates the transfer of funds from the issuing bank to the acquiring bank. The issuing bank deducts the transaction amount from the cardholder's account, while the acquiring bank deposits the funds (minus processing fees) into the merchant's account during the settlement stage. Furthermore, the messaging used to communicate the information across entities during authorization and clearing follows one or more standards (e.g., ISO 8583 standard), and each of the primary stages includes several sub-stages. This entire process requires highly secure and efficient data communication between multiple financial entities, necessitating advanced encryption, tokenization, and fraud detection mechanisms. Given the scale, complexity, and regulatory requirements of credit card processing, continuous innovation is essential to enhance transaction speed, security, and reliability.

### SUMMARY

The following is a non-exhaustive listing of some aspects of the present techniques. These and other aspects are described in the following disclosure.

In some aspects, the techniques described herein relate to a process, including: receiving a first network message that is associated with a first network message flow of a first transaction and that includes first information, wherein the first information includes a first identifier; determining, using derivation logic and at least a portion of the first information, a first network message state of the first network message; routing the first network message to a destination computing device; and storing a first record that includes the first identifier, the first network message state, and at least a portion of the first information in a storage device

Some aspects include a tangible, non-transitory, machine-readable medium storing instructions that when executed by a data processing apparatus cause the data processing apparatus to perform operations including the above-mentioned processes.

Some aspects include a system, including: one or more processors; and a memory storing instructions that when executed by the processors because the processes to effectuate operations of the above-mentioned processes.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of a system environment of a network messaging system, in accordance with some embodiments of the present disclosure;

FIG. 2 illustrates a block diagram illustrating an example of a state management computing device of the network messaging system of FIG. 1, in accordance with some embodiments of the present disclosure;

FIG. 3 illustrates a flowchart of a method of network messaging state management, in accordance with some embodiments of the present disclosure;

FIG. 4A is a communication diagram of an example network message flow of the network messaging system, in accordance with some embodiments of the present disclosure;

FIG. 4B is a communication diagram of an example network message flow of the network messaging system, in accordance with some embodiments of the present disclosure;

FIG. 5 illustrates a table of example derivation logic used to determine a network message state of network messages during the method of FIG. 3, in accordance with some embodiments of the present disclosure;

FIG. 6A illustrates an example user interface of displaying network message state of network messages during the method of FIG. 3, in accordance with some embodiments of the present disclosure;

FIG. 6B illustrates an example user interface of displaying network message state of network messages during the method of FIG. 3, in accordance with some embodiments of the present disclosure; and

FIG. 7 illustrates an example of a computer system that may be implemented by devices illustrated in FIG. 1.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the fields of network messaging and credit card processing networks. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

As discussed above, a credit card processing network is a complex technology that enables security and integrity of financial transactions while maintaining high-speed authorization, clearing, and settlement, fraud prevention, regulatory compliance, and interoperability between different financial institutions. Additionally, credit card processing network technology must efficiently handle large transaction volumes while minimizing latency and errors that could disrupt commerce. Improvements to credit card processing networks are essential to enhance transaction speed, security, transparency, and reliability.

During the various phases of credit card processing there are many sub-states. For example, during the authorization phase the credit card transaction may be authorized, fully reversed, partially reversed, or other sub-states that would be apparent to one of skill in the art in possession of the present disclosure. In the clearing phase, the credit card transaction may be in a fully cleared state, a partially cleared state, a partially reversed state, a chargeback state, or other clearing sub-states that would be apparent to one of skill in the art in possession of the present disclosure. The authorization phase generally occurs in an online mode while clearing generally happens in a batch mode. Knowing the state of the network messaging for the transaction may be important to actors in the credit card processing system for various reasons. However, current credit card processing systems and standards used to transmit the network messages lack the capability to track the exact status of the transaction and the network messages associated with the transaction, especially for the clearing phase in the form of batch files. The batch file may contain multiple clearing first presentment records of the authorized transactions. Due to many technical challenges, sometimes the batch files are not selected from a next generation file transfer from the credit card network switch resulting in delayed acknowledgement to a participant such as the merchant. Participants are often left with little options to determine the status of the transaction record and current switching applications do not have any capability to maintain a transaction record status for the participants.

In addition to the inability of participants knowing a state status of a transaction, currently, participants must maintain the total authorized amount and total clearing amount by considering multiple legs of the transaction especially for one authorization and multiple clearing legs (e.g., a partial shipment use case). The current network messaging systems create complexity for the customers to reconcile multiple records to arrive at a final transaction amount. The network does not provide these details to the customer during the clearing processing, and it results in many participant inquiries.

The systems and methods of the present disclosure provide for an improved switching domain in the card network. The switching domain may be configured to track a transaction state of each of the legs of a network message flow of the transaction using a derivation logic. The transaction state may be filtered from the network message flow using a transaction lifecycle identifier and presented via an application programming interface (API) to an application at the participant's terminal to understand the state of a particular transaction. Furthermore, the derivation logic may compute the total authorized and total cleared amounts at the transaction lifecycle identifier level such that those amounts may be traced. The systems and methods provide for an efficient mechanism to provide state status of the transaction as well as total authorized and cleared amounts without compromising security and increasing latency of the credit card processing system.

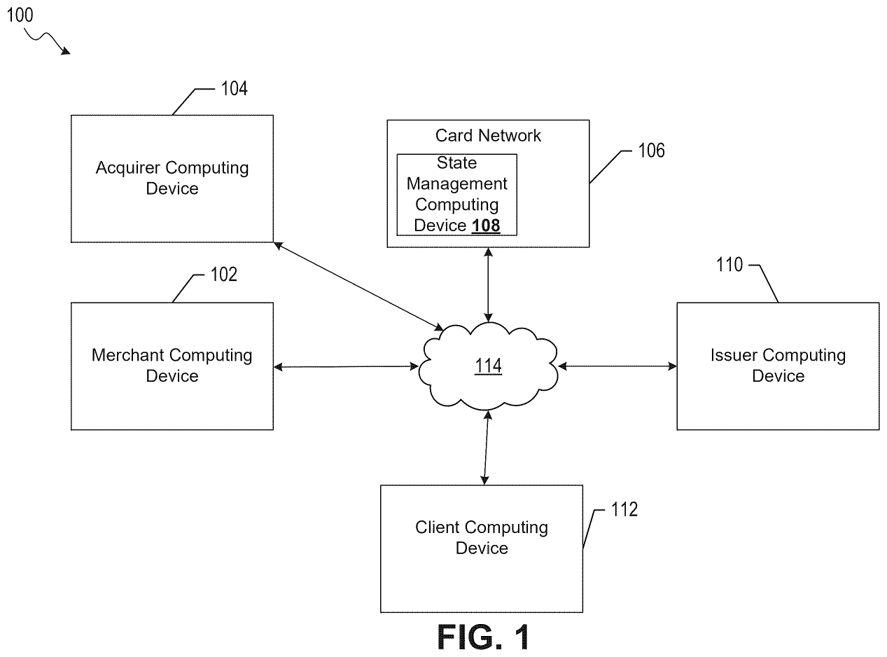

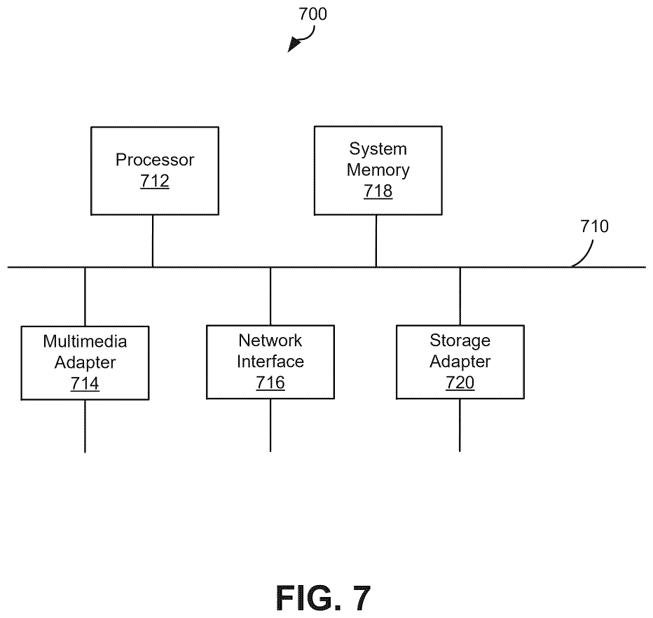

FIG. 1 depicts a block diagram of an example of a network messaging system 100, consistent with some embodiments. In the illustrated example and describe herein, the network messaging system 100 provides an example credit card payment processing system. However, other network messaging systems and credit card payment processing systems may be contemplated and fall under the scope of the present disclosure. In some embodiments, the network messaging system 100 may include a merchant computing device 102, an acquirer computing device 104, a card network 106 that includes a state management computing device 108, an issuer computing device 110 and a client computing device 112. The merchant computing device 102, the acquirer computing device 104, the card network 106, the issuer computing device 110 and the client computing device 112 may be in communication with each other over a network 114, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, or other network through which network messaging system 100 components may communicate. In some embodiments, the various components may network messaging system 100 be implemented with computing devices like those shown in FIG. 7.

In various embodiments, the network messaging system 100 may also include or may be in connection with the merchant computing device 102. While one merchant computing device 102 is illustrated, in implementation, the network messaging system 100 may include hundreds, thousands, tens of thousands, or millions of merchant computing devices with different sets of one or more merchant computing devices being associated with a respective merchant. The merchant computing device 102 may include one or more server devices, storage systems, cloud computing systems, or other computing devices (e.g., desktop computing device, laptop/notebook computing device, tablet computing device, mobile phone, etc.). In various embodiments, the merchant computing device 102 may also include various combinations of hardware or software having one or more processors and capable of reading instructions stored on a tangible non-transitory machine-readable medium for execution by the one or more processors. Consistent with some embodiments, the merchant computing device 102 includes a machine-readable medium, such as a memory (not shown) that includes instructions for execution by one or more processors (not shown) for causing the merchant computing device 102 to perform specific tasks. In some embodiments, the instructions may be executed by the one or more processors in response to interaction by the user. In some examples, the merchant computing device 102 may further be one or more servers that hosts applications for the client computing devices 120 or a different set of client computing devices than client computing devices 120 (e.g., customer client computing devices versus administrative client computing devices). For example, the merchant computing device 102 may be a server that hosts an application or website for online transactions. In other examples, the merchant computing device may be a point of sale (POS) terminal at a merchant location, a mobile POS terminal, a card reader, or other merchant computing device that would be apparent to one of skill in the art in possession of the present disclosure. The merchant computing device 102 may perform the capturing of the credit card information from a credit card or receive manual inputs of a credit card as well as other processes discussed in more detail below.

In various embodiments, the network messaging system 100 may also include or may be in connection with the acquirer computing device 104. While one acquirer computing device 104 is illustrated, in implementation, the network messaging system 100 may include hundreds, thousands, tens of thousands, or millions of acquirer computing devices 104 belonging to different financial institutions. The acquirer computing device 104 may include one or more server devices, storage systems, cloud computing systems, or other computing devices (e.g., desktop computing device, laptop/notebook computing device, tablet computing device, mobile phone, etc.). In various embodiments, the acquirer computing device 104 may also include various combinations of hardware or software having one or more processors and capable of reading instructions stored on a tangible non-transitory machine-readable medium for execution by the one or more processors. Consistent with some embodiments, the acquirer computing device 104 includes a machine-readable medium, such as a memory (not shown) that includes instructions for execution by one or more processors (not shown) for causing the acquirer computing device 104 to perform specific tasks. In some embodiments, the acquirer computing device 104, in a credit card transaction, may be provided by an acquiring bank that is the financial institution that processes credit or debit card payments on behalf of a merchant. When a customer makes a purchase using a card, the acquirer computing device 104 may receive the payment request from the merchant, forwards it to the appropriate card network 106 (e.g., Mastercard), and then to the issuing bank for authorization (e.g., issuer computing device 110). Once the transaction is approved, the acquirer computing device 104 may facilitate the transfer of funds from the issuing bank to the merchant's account, minus any fees. Essentially, the acquirer computing device 104 acts as the intermediary that enables merchants to accept card payments securely and efficiently.

In various embodiments, the network messaging system 100 may also include or may be in connection with the card network 106. For example, the card network 106 may include one or more server devices, storage systems, cloud computing systems, or other computing devices (e.g., desktop computing device, laptop/notebook computing device, tablet computing device, mobile phone, etc.). For example, the card network 106 may include the state management computing device 108 that may perform some or all the functionality described herein. In some embodiments, the state management computing device 108 may include a server or be implemented in the switching domain of the card network 106, and thus may be provided by one or more switches. In various embodiments, the card network 106 or state management computing device 108 may also include various combinations of hardware or software having one or more processors and capable of reading instructions stored on a tangible non-transitory machine-readable medium for execution by the one or more processors. Consistent with some embodiments, the card network 106 or the state management computing device 108 includes a machine-readable medium, such as a memory (not shown) that includes instructions for execution by one or more processors (not shown) for causing the card network 106 or the state management computing device 108 to perform specific tasks. In some embodiments, the card network 106 or the state management computing device 108 may provide network messaging state management as discussed herein. The card network 106 may act as the central hub that facilitates communication and data exchange between the acquiring bank (merchant's bank) and the issuing bank (cardholder's bank). Its primary function may be to route the transaction information in network messages securely and efficiently, ensuring the payment request from the acquirer reaches the correct issuer for authorization. Once the issuer approves or declines the transaction, the card network sends the response back to the acquirer. Additionally, the card network 106 may set the rules and standards for card transactions, manage dispute resolution processes, and ensure the overall integrity and security of the payment ecosystem.

The card network 106 may include a large-scale distributed infrastructure designed for high-speed, secure transaction processing. Central to the card network 106 may include data centers housing high-performance servers that handle transaction routing, authorization, and fraud detection. The card network 106 may include network hardware like routers, switches, and firewalls that manage data flow and ensure security, while storage systems retain vast amounts of transaction and account data. The card network may include specialized security appliances, such as hardware security modules (HSMs), may encrypt sensitive information, and may provide intrusion detection systems that guard against cyber threats. The card network 106 may include load balancers that may be used to distribute traffic across servers, ensuring scalability, reliability, and continuous availability. Other components and features of the card network 106 may be contemplated and recognized by those skilled in the art in possession of the present disclosure.

In various embodiments, the network messaging system 100 may also include or may be in connection with the issuer computing device 110. For example, the issuer computing device 110 may include one or more server devices, storage systems, cloud computing systems, or other computing devices (e.g., desktop computing device, laptop/notebook computing device, tablet computing device, mobile phone, etc.). In various embodiments, the issuer computing device 110 may also include various combinations of hardware or software having one or more processors and capable of reading instructions stored on a tangible non-transitory machine-readable medium for execution by the one or more processors. Consistent with some embodiments, the issuer computing device 110 includes a machine-readable medium, such as a memory (not shown) that includes instructions for execution by one or more processors (not shown) for causing the issuer computing device 110 to perform specific tasks. In some embodiments, the issuer computing device 110, may be provided by an issuing bank that is responsible for providing payment cards to cardholders and managing their associated credit or debit accounts. As such, the network messaging system 100 may include tens, hundreds, thousands, or millions of issuer computing devices 110 Upon initiation of a transaction by a cardholder at a merchant terminal (e.g., the merchant computing device 102), the issuer computing device 110 may receive an authorization request via the card network 106 and evaluates the request based on factors such as account status, available credit, and fraud detection parameters. The issuer computing device 110 may then transmit an approval or denial response back through the card network 106 to the acquirer computing device 104. In approved transactions, the issuer is responsible for transferring the authorized funds to the acquiring bank and subsequently billing the cardholder. Additionally, the issuer computing device 110 may manage account services, risk assessment, and customer support, and may provide dispute resolution and chargeback processing. The issuer computing device 110 may include secure servers, databases, fraud detection engines, and encryption modules, all designed to ensure transaction integrity, security, and compliance with card network standards.

In various embodiments, the network messaging system 100 may also include or may be in connection with the client computing device 112. For example, the client computing device 112 may include one or more desktop computing device, laptop/notebook computing device, tablet computing device, mobile phone, wearable computing devices, or other computing devices In various embodiments, the client computing device 112 may also include various combinations of hardware or software having one or more processors and capable of reading instructions stored on a tangible non-transitory machine-readable medium for execution by the one or more processors. Consistent with some embodiments, the client computing device 112 includes a machine-readable medium, such as a memory (not shown) that includes instructions for execution by one or more processors (not shown) for causing the client computing device 112 to perform specific tasks. In some embodiments, the client computing device 112, may be provided by a customer/user. For example, a consumer interacting with a merchant website hosted by the merchant computing device 102 to complete a transaction for a good or service. In other embodiments, the client computing device 112 may be an administrator computing device that is used to manage one or more components of the network messaging system 100. In other embodiments, the client computing device 112 may belong to a customer of the card network such as a merchant and may be used herein to request state status of a transaction and the network messages associated with the transaction by interacting with the state management computing device 108. As such, while one client computing device 112 is illustrated, one of skill in the art will recognize that hundreds, thousands, or millions of client computing devices 112 around the world may be provided in the network messaging system 100.

While the network messaging system 100 is described from the perspective of a credit card payment processing network, the acquirer computing device 104 and the issuer computing device 110 may generically be network messaging computing devices such that they may be senders or recipients in a network message flow. The card network 106 may generically be a network message switch or broker that facilitates the routing and distribution of the network messages to the various network messaging computing devices.

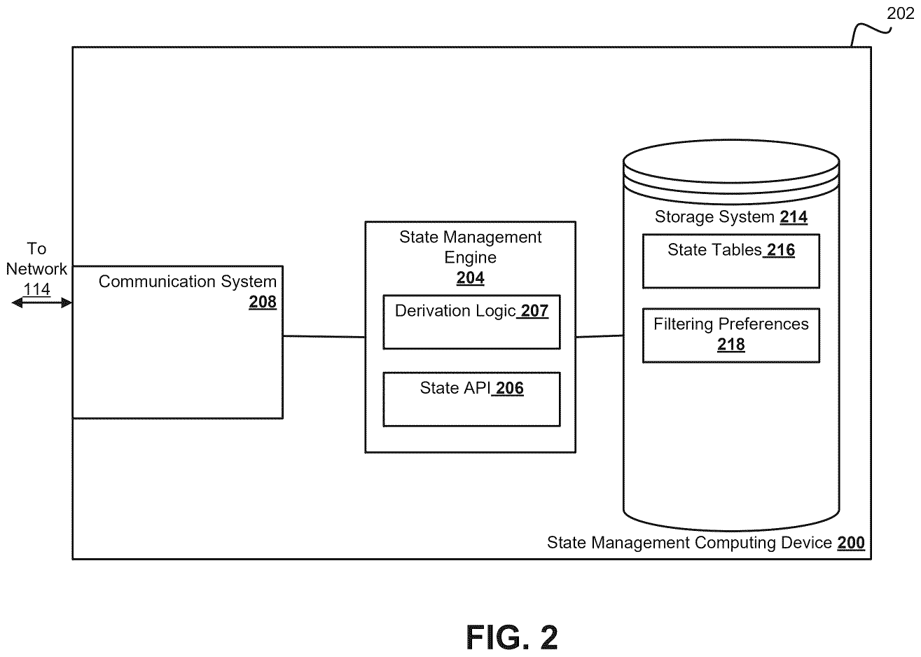

FIG. 2 illustrates an embodiment of a state management computing device 200 that may be the state management computing device 108 discussed above with reference to FIG. 1. In the illustrated embodiment, the state management computing device 200 includes a chassis 202 that houses the components of the state management computing device 200. The state management computing device 200 may be provided by a server, network switch, a router, a gateway or other computing device that receives and routes network messages for transactions between the issuer computing device 110, the merchant computing device 102, or the acquirer computing device 104. Several of these components are illustrated in FIG. 2. For example, the chassis 202 may house a processing system and a non-transitory memory system that includes instructions that, when executed by the processing system, cause the processing system to provide a state management engine 204 that is configured to perform the functions of the state management engine or the state management computing devices, discussed below. In the specific example illustrated in FIG. 2, the state management engine 204 is configured to provide a state application programming interface (API) 206 and derivation logic 207. The state API 206 may allow client computing devices 112 to communicate with the state management engine 204 such that network message states may be accessed. The derivation logic 207 may include logic that is used to determine a state of a network message flow (e.g., a state of credit card transaction) using information from the most recent network message associated with the network message flow.

The chassis 202 may further house a communication system 208 that is coupled to the state management engine 204 (e.g., via a coupling between the communication system 208 and the processing system). The communication system 208 may include software or instructions that are stored on a computer-readable medium and that allow the state management computing device 200 to send and receive messages through the communication networks discussed above. For example, the communication system 208 may include a communication interface to provide for communications through the network 114 as detailed above.

The chassis 202 may house a storage device (not illustrated) that provides a storage system 214 that is coupled to the state management engine 204 through the processing system. The storage system 214 may be configured to store data, applications, state tables 216, filtering preferences 218, or instructions described in further detail below and used to perform the functions described herein. While a specific example of the state management computing device 200 is illustrated, one of skill in the art in possession of the present disclosure will recognize that different configurations may be contemplated without departing from the scope of the present disclosure.

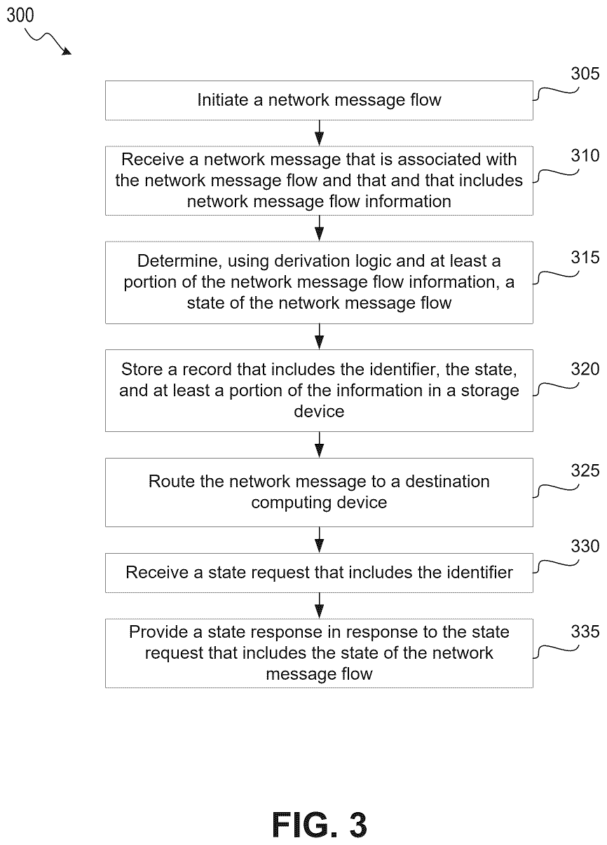

FIG. 3 illustrates a flowchart of an example method 300 for network messaging state management provided by the network messaging system 100 of FIG. 1 and described with respect to the components of FIG. 1 and FIG. 2. The method 300 may begin at block 305 where a network messaging flow is initiated. In an embodiment, at block 305, a network messaging flow may be initiated that causes a series of network messages to be exchanged via the network messaging system 100. For example, the network messaging flow may be initiated by the merchant computing device completing a transaction with credit card at the merchant computing device 102. However, “transactions” other than credit card or monetary transactions may be contemplated such that “transaction” should broadly be interpreted as an instance that causes a network message flow to be initiated. The input of the credit card information associated with a transaction may cause an initial authorization message flow that may cause an authorization request message to be provided by the acquirer computing device 104 to the issuer computing device 110 via the card network 106. The authorization request may result in the issuer computing device 110 providing an authorization request response that indicates whether the transaction should be authorized or not, which is communicated via the card network 106 to the acquirer computing device 104 and the merchant computing device 102 indicating whether the transaction has been approved or denied. The clearing messaging flow may be another network messaging flow that can be initiated based on a time condition being satisfied or other instructions to batch process a plurality of authorized transactions and route the authorized transactions through the card network 106 to the various issuer computing devices 110 associated with each card holders' respective banks. As such, the clearing messaging flow may be related to individual authorization messaging flows.

The method 300 may proceed to block 310 where a first network message that is associated with the network message flow and that includes first network message flow information is received. In an embodiment, at block 310, the state management engine 204 of the state management computing device 108/200 may receive a first network message associated with a first transaction (e.g., credit card processing for a transaction of a good or service at the merchant computing device) that includes first transaction information. In an embodiment, the state management computing device 108/200 may be provided by a switch on the switch domain of the card network 106. By locating the state management engine 204 on in the switch domain, faster processing may be realized compared to other locations in the card network 106. The switch has direct access to network messages and also provides unique queuing features that ensure network messages are processed promptly, minimizing delays. As such, latency and bottlenecks are reduced by locating the state management engine 204 on the switch. As such, when making routing decisions using routing logic to capture various data in data elements of the network messages, the state management engine 204 may be capturing information from the data elements to determine state. As such, the state management engine 204 may include routing logic or operate in conjunction with separate routing logic.

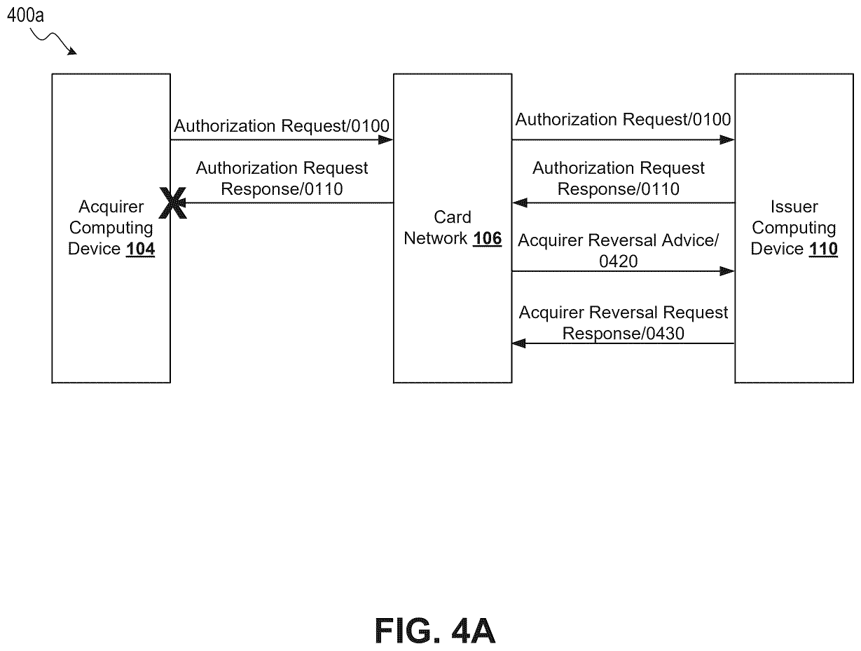

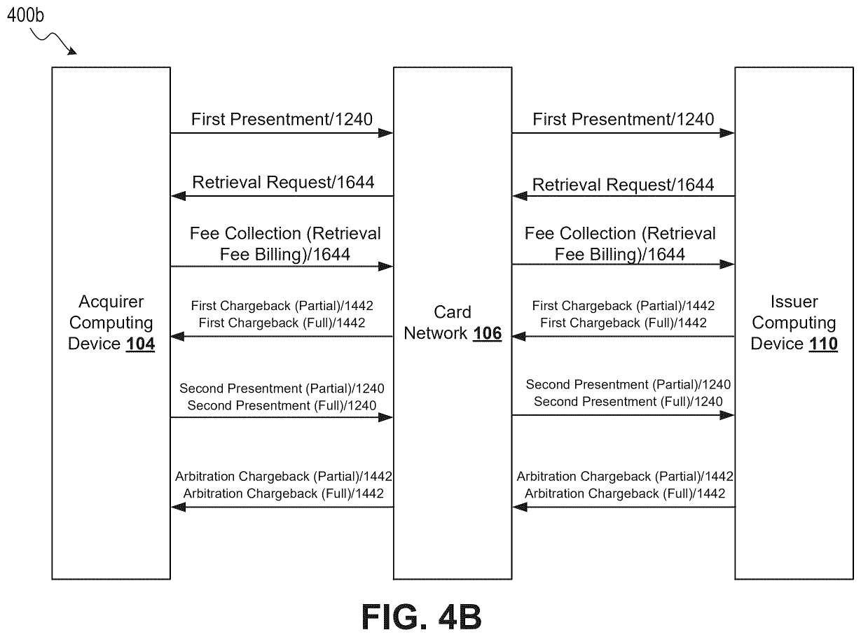

In various embodiments, the first transaction information may include an account identifier (e.g., a primary account number (PAN)) or other identifiers, an amount of the transaction, a date and time stamps, or other information that is included in network messages that follow the ISO 8583 standard, the ISO 20022 standard, or other messaging standards. In a specific example, a first leg of an authorization message flow may include an authorization request 0100 from the acquirer computing device 104 to the card network 106 that then routes that authorization request 0100 to the card holder's issuer computing device 110 as illustrated in a authorization message flow 400a of FIG. 4A. FIG. 4A illustrates one example of the authorization message flow 400a where a connection is lost with the acquirer computing device 104, preventing an authorization request response/0110 from reaching the acquirer computing device 104. The card network 106 may generate an acquirer reversal advice message (0420) and provide that message to the issuer computing device 110 that may respond with an acquirer reversal request response/0430. The card network 106 may perform a state management operation where a state of the network message flow is captured and stored for each message it receives, sends, or generates as discussed below.

FIG. 4B illustrates a clearing message flow 400b with various clearing message types (e.g., 124, 1644, and 1442. As can be seen, message type alone may not be determinative of the state of the network messaging flow as the same message type may be used for different situations.

In some embodiments, at the stage of the first initial message of the network message flow for card transaction processing, the card network 106 may assign a life cycle identifier that represents the transaction as the networking messaging for the transaction may experience multiple network messaging flows (e.g., an authorization messaging flow and a clearing messaging flow). The life cycle identifier may identify the transaction across the various network messaging flows that may occur on the network messaging system 100. The card network 106 may communicate the life cycle identifier to the acquirer computing device 104 and the issuer computing device 110 so that the life cycle identifier may be added to other messages in the network message flow. For messages that are generated based on the ISO 8583 standard, the life cycle identifier may be provided in data element 105, sub-element 001 of the message.

The method 300 may proceed to block 315 where a state of the network message flow is determined using derivation logic and at least a portion of the information included in the network message. In an embodiment, at block 315, the state management engine 204 may determine a state of the network message flow using the derivation logic 207 and information included in the network message. In various embodiments, the state management engine 204 on the switch may perform a real-time lifecycle lookup. The switch may perform lifecycle lookups with the state tables 216 on-the-fly, retrieving historical details associated with a TraceID to derive the transaction state/network message state and adjust authorized versus cleared amounts as well as other state information. The state management engine 204 may also perform post-hoc processing. If real-time processing is delayed due to slow responses from the storage system 214 such that a latency satisfies a predetermined latency threshold, the same operations are performed post-hoc (offline mode), ensuring continuity without impacting processing and routing speed of the network messages as they are processed by the card network 106.

In addition to any previous state status or network message information obtained from previous network messages that may be used to determine a state, the information that the derivation logic 207 may use to determine the state of the network message flow from the received network message may include a message type, presence or absence of a life cycle identifier, presence or absence of a trace identifier, a file identifier, a transaction amount, a transaction attribute, a final authorization indicator, or other information. In the specific example of credit card transaction processing message flows, Table 1 illustrates example information and derivation logic 207 to determine a state of the authorization network message flow:

TABLE 1

| Derivation Logic | Message Flow State |
|---|---|
| Message Type = 0100 (Authorization | NORA′—Normal Authorized |
| Request)& | |
| Trace ID (Data element 48.63) or | |
| Transaction Link ID (Data element 105) is | |
| MISSING & DE61.7 (POS Transaction | |
| Status) = 0 (Normal request) or 1 (Deferred | |
| Authorization) | |
| Message Type = 0100 (Authorization | Paut′—Preauthorized |
| Request)& | |
| Trace ID (Data element 48.63) or | |
| Transaction Link ID (Data element 105) is | |
| MISSING & DE61.7 (POS Transaction | |
| Status) = 4 (Preauthorized request) | |
| Message Type = 0100 (Authorization | INCR′—IncrementalAuthorized |
| Request)& | |
| Trace ID (Data element 48.63) or | |
| Transaction Link ID (Data element 105) is | |
| PRESENT & DE61.7 (POS Transaction | |
| Status) = 4 (Preauthorized request) | |
| Message Type = 0100 (Authorization | PACP′—PreAuthorizationCompleted |
| Request)& | |
| Trace ID (Data element 48.63) or | |
| Transaction Link ID (Data element 105) is | |
| PRESENT & DE48.61 = 1 (Final | |
| Authorization Indicator) | |
| Message Type = 0100 (Authorization | FAUT′—FinalAuthorized |
| Request)& | |
| Trace ID (Data element 48.63) or | |
| Transaction Link ID (Data element 105) is | |
| MISSING & (DE48.61 = 1 (Final | |
| Authorization Indicator) OR DE61.7 = 0 | |
| (Normal request (original presentment)) | |
| Message Type = 0400 (Reversal Request)& | AREV′—AuthorizationFullReversed |
| Trace ID (Data element 48.63) or | |
| Transaction Link ID (Data element 105) is | |
| PRESENT & DE4 (Transaction Amount) is | |
| equal to the original transaction amount | |
| associated with the corresponding | |
| authorization. | |
| Message Type = 0400 (Reversal Request)& | APRV′—AuthorizationPartialReversed |
| Trace ID (Data element 48.63) or | |
| Transaction Link ID (Data element 105) is | |
| PRESENT & DE4 (Transaction Amount) is | |
| less than the original transaction amount | |
| associated with the corresponding | |
| authorization. | |

In the specific example of credit card transaction processing message flows, Table 2 illustrates example information and derivation logic 207 to determine several example states of the clearing network message flow:

TABLE 2

| Derivation Logic | Message Flow State |
|---|---|
| Message Type = 1240-200 (First | FNFC′—FinancialNotificationFirstFullCleared |
| Presentment)& DE4 (Transaction | |
| amount) is equal to or greater than the | |
| associated authorized amount | |
| Message Type = 1240-200 (First | FNFC′—FinancialNotificationFirstPartiallyCleared |
| Presentment)& DE4 (Transaction | |
| amount) is less than the associated | |
| authorized amount | |
| Message Type = 1240-200 (First | FNFC′—FinancialNotificationFirstFullReversed |
| Presentment)& PDS 25.1 = ‘R’ | |
| (Message Reversal Indicator) & DE4 | |
| (Transaction amount) is equal to the | |
| associated Financial Notification | |
| (original first presentment) | |
| Message Type = 1240-200 (First | FNFC′—FinancialNotificationFirstPartialReversed |
| Presentment)& PDS 25.1 = ‘R’ | |
| (Message Reversal Indicator) & DE4 | |
| (Transaction amount) is less than the | |
| associated Financial Notification | |
| (original first presentment) | |
| Message Type = 1442-450 (First | CBIF′—Full Chargeback |
| Chargeback (Full)) & DE4 | |
| (Chargeback amount) is equal to the | |
| associated Financial Notification | |
| (original first presentment) | |
| Message Type = 1442-453 (First | CBFP′—Partial Chargeback |
| Chargeback (Partial)) & DE4 | |
| (Chargeback amount) is less than the | |
| associated Financial Notification | |
| (original first presentment) | |

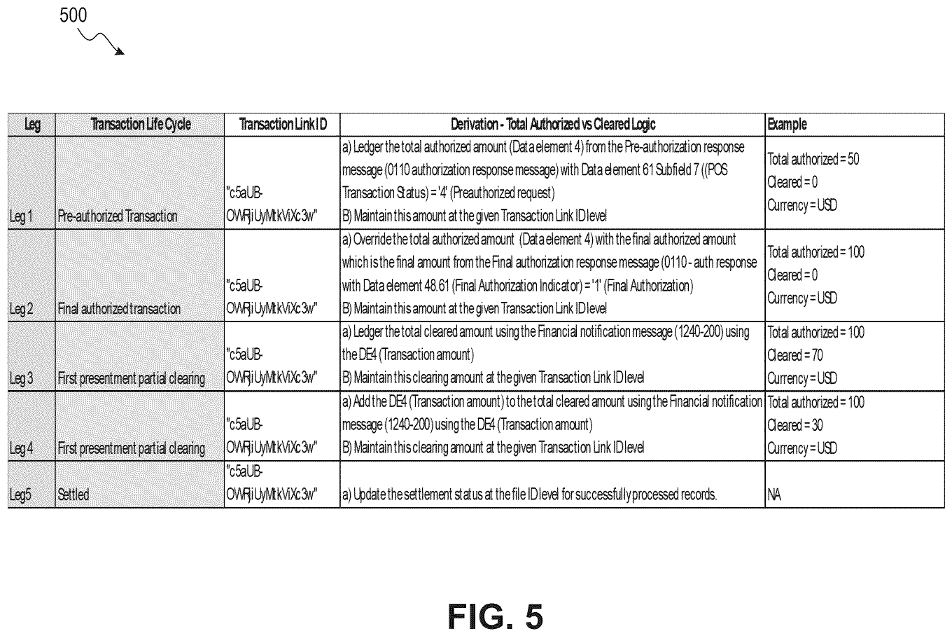

In some embodiments, the derivation logic 207 may also determine other information from the network messages. Continuing with the example network messaging for of credit card transaction processing, a total authorized amount versus a total cleared amount may be determined at each network message leg of the network messaging flow. FIG. 5 illustrates a table 500 of example derivation logic and information for determining a total authorized amount and a total cleared amount.

The method 300 may proceed to block 320 where a record that includes the identifier, the state, and at least a portion of the information is stored in a storage device. In an embodiment, at block 320, the state management engine 204 may store a record of the identifier of the network message flow, the transaction state, and at least a portion of the information included in the network message in the state tables 216 of the storage system 214. In various embodiments, the state management engine 204 may include unique methods or techniques for storing state information that reduces storage requirements. In some embodiments, data may be stored in an encrypted format, reducing the need for additional fields in the state tables 216, thereby conserving database space and enhancing processing efficiency. Furthermore, state information may be hashed, allowing for efficient storage and retrieval while maintaining data security. In various embodiments, the state management engine 204 may provide for dynamic updates. For example, the state management engine 204 may dynamically update state information, ensuring that only relevant data is stored, thus conserving space. If derivation logic 207 determines that a record already exists for the identifier, the derivation logic 207 may replace the old record with the newly created record. In other embodiments, the derivation logic 207 may merge the records together to create a running ledger of the various states of the network messaging flow while removing unnecessary data.

The method 300 may proceed to block 325 where the first network message is routed to a destination computing device. In an embodiment, at block 325, the card network 106 may route the network message to its destination computing device such as the acquirer computing device 104 or the issuer computing device 110 according to routing instructions determined based on information in the network message. For example, the card network 106 may use the information from the network message to determine an issuer computing device that the network message is associated with (e.g., a bank associated with the primary account number included in the network message). Specifically, the switch logic of the card network 106, during an authorization request, may read the PAN to determine a bank identification number (BIN) and look up a routing table to identify the issuer. The switch logic may then format the authorization request and send the request to the issuer computing device 110.

The method 300 may proceed to block 330 where a state request is received. In an embodiment, at block 330, the state management engine 204 may receive a state request via the state API 206. The state request may include one or more identifiers such as the life cycle identifier or other identifiers (e.g., a banknet reference number or a file identifier). The state management engine 204 may use the identifier received in the state request to locate the identifier in the state table 216 to obtain any record that includes the identifier.

The method 300 may proceed to block 335 where a state response is provided in response to the state request. In an embodiment, at block 335, the state management engine 204 via the state API 206, may provide a state response to the user making the request. The state response may include state information from the state table 216 associated with the provided identifier in the state request. The state response may include the most current state or a log of the all the recorded states associated with the provided identifier for the network message flow. The state response may cause a user interface on the client computing device 112 to display the state information and any other information included in the state response such as the total cleared amount and the total authorized amount.

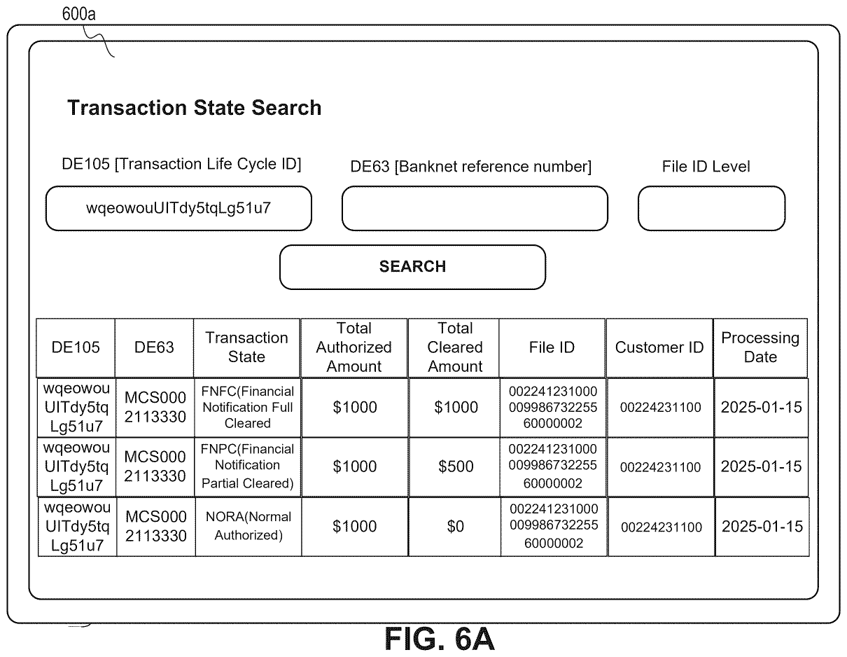

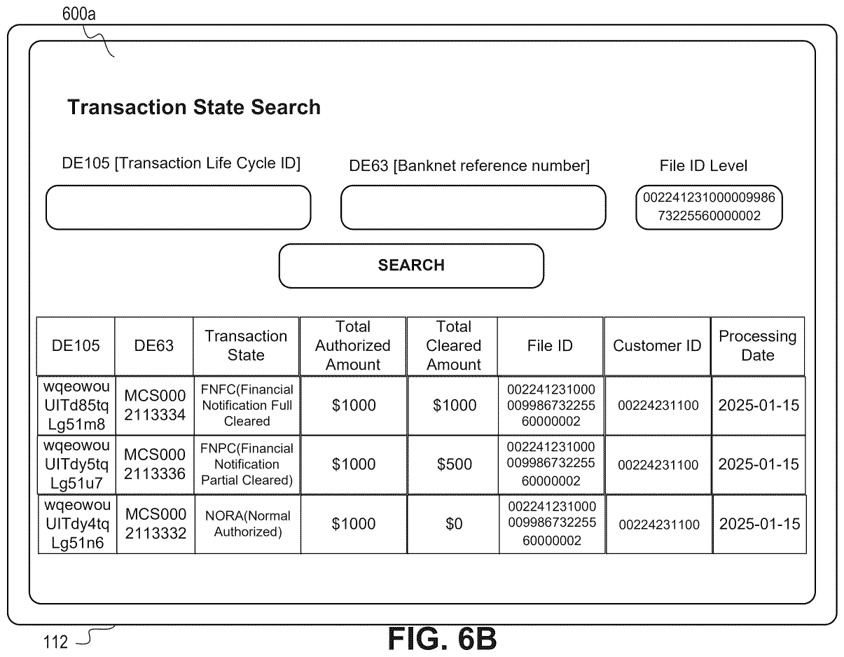

FIG. 6A illustrates an example user interface 600a on a client computing device 112 where the user may enter an identifier to make the state request and receive various state information associated with a network message flow from the state response. In the illustrated example, the user enters a life cycle identifier, which causes the retrieval and display of the lifecycle identifier, a banknet reference number, a transaction state, a total authorized amount, a total cleared amount, a file identifier, a customer identifier, and a processing date. FIG. 6B illustrates an example user interface 600b on a client computing device 112 where a file identifier is entered as the search criteria and the state management engine 204 returns all network messaging flows associated with that file identifier and their associated states and identifiers as well as the total authorized amount and total cleared amount for those transactions.

While the method 300 describes a state request and a state response, the state information for a network message flow may be communicated to a user in various ways. In one example, the state management engine 204 may use filtering preferences 218 that may be user specified or predetermined filters that cause the state management engine to 204 to determine state for specific network message types while not determining state of other network message types. Alternatively, or in addition, certain states may be of particular interest to a user. Using the filtering preferences 218, the state management engine 204 may generate alerts for those states and send or push to the client computing device 212 without a state request. Those alerts may be sent in real-time or based on a transmission schedule. In some embodiments, the alerts may be formatted into data blocks according to a user-specified information format. The alert may activate the user's application on the user's client computing device via a first communication channel such as a wireless communication channel. The alert may include a link to the state API 206 accessible via a second communication channel that is not activated such that the user may obtain the state of a network message from the state tables 216 when the second communication channel is activated.

FIG. 7 illustrates an example of a computer system 700 that may be implemented by devices illustrated in FIG. 1. The computer system 700 may be part of or include the network messaging system 100 to perform the functions and features described herein. For example, various ones of the devices of the network messaging system 100 may be implemented based on some or all of the computer system 700. The computer system 700 may include, among other things, an interconnect 710, a processor 712, a multimedia adapter 714, a network interface 716, a system memory 718, and a storage adapter 720.

The interconnect 710 may interconnect various subsystems, elements, and/or components of the computer system 700. As shown, the interconnect 710 may be an abstraction that may represent any one or more separate physical buses, point-to-point connections, or both, connected by appropriate bridges, adapters, or controllers. In some examples, the interconnect 710 may include a system bus, a peripheral component interconnect (PCI) bus or PCI-Express bus, a HyperTransport interconnect, an industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 710 may allow data communication between the processor 712 and system memory 718, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 712 may control operations of the computer system 700. In some examples, the processor 712 may do so by executing instructions such as software or firmware stored in system memory 718 or other data via the storage adapter 720. In some examples, the processor 712 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 714 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 716 may provide the computer system 700 with an ability to communicate with a variety of remote devices over a network. The network interface 716 may include, for example, an Ethernet adapter, a Fibre Channel adapter, and/or other wired- or wireless-enabled adapter. The network interface 716 may provide a direct or indirect connection from one network element to another, and facilitate communication to, and between, various network elements. The storage adapter 720 may connect to a standard computer-readable medium for storage and/or retrieval of information, such as a fixed disk drive (internal or external).

Other devices, components, elements, or subsystems (not illustrated) may be connected in a similar manner to the interconnect 710 or via a network. The devices and subsystems can be interconnected in different ways from that shown in FIG. 7. Instructions to implement various examples and implementations described herein may be stored in computer-readable storage media such as one or more of system memory 718 or other storage. Instructions to implement the present disclosure may also be received via one or more interfaces and stored in memory. The operating system provided on computer system 700 may be MS-DOS®, MS-WINDOWS®, OS/2®, OS X®, IOS®, ANDROID®, UNIX®, Linux®, or another operating system.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a datacenter or geographically), or otherwise differently organized. The functionality described herein may be provided by one or more processors of one or more computers executing code stored on a tangible, non-transitory, machine-readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computing system” performing step A and “the computing system” performing step B can include the same computing device within the computing system performing both steps or different computing devices within the computing system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking at the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

Embodiment 1. A system, comprising: a non-transitory memory; and one or more hardware processors coupled to the non-transitory memory and configured to read instructions from the non-transitory memory to cause the system to perform operations comprising: receiving a first network message that is associated with a first network message flow of a first transaction and that includes first information, wherein the first information includes a first identifier; determining, using derivation logic and at least a portion of the first information, a first network message state of the first network message; routing the first network message to a destination computing device; and storing a first record that includes the first identifier, the first network message state, and at least a portion of the first information in a storage device.

Embodiment 2. The system of embodiment 1, wherein the operations further comprise: generating and associating a first life cycle identifier to the first identifier, wherein determining, using the derivation logic and the at least a portion of the first information, the first network message state of the first network message is based on a presence or absence of the first life cycle identifier, and wherein the first life cycle identifier identifies the first transaction across the first network message flow and at least one second network message flow.

Embodiment 3. The system of any one of embodiments 1-2, wherein the operations further comprise: receiving a second network message that is associated with the first network message flow and that includes second information; determining, using the derivation logic and at least a portion of the second information, a second network message state of the second network message, wherein the second network message state is different than the first network message state; routing the second network message to a destination computing device; and updating the first record with the second network message state.

Embodiment 4. The system of any one of embodiments 1-3, wherein the operations further comprise: determining, based on at least a portion of the first information, a total authorized amount and a total cleared amount of the first transaction; and storing the total authorized amount and the total cleared amount in the first record.

Embodiment 5. The system of any one of embodiments 1-4, wherein the operations further comprise: injecting a first life cycle identifier into the first network message or any second network message that is generated based on the first network message.

Embodiment 6. The system of any one of embodiments 1-5, wherein the first network message is an authorization request message that follows an ISO 8583 standard, and wherein the first network message flow is an authorization message flow.

Embodiment 7. The system of any one of embodiments 1-6, wherein the operations further comprise: receiving, from a user device via an application programming interface (API), a request for a network message state of the first transaction, wherein the request includes the first identifier; retrieving, using the first identifier, the first network message state from the first record; and providing the first network message state to the user device for display through a user interface.

Embodiment 8. The system of any one of embodiments 1-7, wherein the first information includes a message type of the first network message, and wherein the at least a portion of the first information, used by the derivation logic to determine the first network message state of the first transaction, includes the message type.

Embodiment 9. The system of any one of embodiments 1-8, wherein the at least a portion of the first information that is used by the derivation logic to determine the first network message state of the first transaction includes at least two of a message type of the first network message, a presence or an absence of at least one of a file identifier or a life cycle identifier, a point of sale transaction status, a final authorization indicator, a transaction amount, an original transaction amount associated with an authorization, a message reversal indicator, or an original first presentment.

Embodiment 10. A method, performing any one of the operations in embodiments 1-9.

Embodiment 11. A tangible, non-transitory, machine-readable medium storing instructions that when executed by one or more processors effectuate operations performing any one of the operations in embodiments 1-9.

What is claimed is:

1. A system, comprising:
a non-transitory memory; and
one or more hardware processors coupled to the non-transitory memory and configured to read instructions from the non-transitory memory to cause the system to perform operations comprising:
receiving a first network message that is associated with a first network message flow of a first transaction and that includes first information, wherein the first information includes a first identifier;
determining, using derivation logic and at least a portion of the first information, a first network message state of the first network message;
routing the first network message to a destination computing device; and
storing a first record that includes the first identifier, the first network message state, and at least a portion of the first information in a storage device.

2. The system of claim 1, wherein the operations further comprise:
generating and associating a first life cycle identifier to the first identifier, wherein determining, using the derivation logic and the at least a portion of the first information, the first network message state of the first network message is based on a presence or absence of the first life cycle identifier, and wherein the first life cycle identifier identifies the first transaction across the first network message flow and at least one second network message flow.

3. The system of claim 1, wherein the operations further comprise:
receiving a second network message that is associated with the first network message flow and that includes second information;
determining, using the derivation logic and at least a portion of the second information, a second network message state of the second network message, wherein the second network message state is different than the first network message state;
routing the second network message to a destination computing device; and
updating the first record with the second network message state.

4. The system of claim 1, wherein the operations further comprise:
determining, based on at least a portion of the first information, a total authorized amount and a total cleared amount of the first transaction; and
storing the total authorized amount and the total cleared amount in the first record.

5. The system of claim 1, wherein the operations further comprise:
injecting a first life cycle identifier in the first network message or any second network message that is generated based on the first network message.

6. The system of claim 1, wherein the first network message is an authorization request message that follows an ISO 8583 standard, and wherein the first network message flow is an authorization message flow.

7. The system of claim 1, wherein the operations further comprise:
receiving, from a user device via an application programming interface (API), a request for a network message state of the first transaction, wherein the request includes the first identifier;
retrieving, using the first identifier, the first network message state from the first record; and
providing the first network message state to the user device for display through a user interface.

8. The system of claim 1, wherein the first information includes a message type of the first network message, and wherein the at least a portion of the first information, used by the derivation logic to determine the first network message state of the first transaction, includes the message type.

9. The system of claim 1, wherein the at least a portion of the first information that is used by the derivation logic to determine the first network message state of the first transaction includes at least two of a message type of the first network message, a presence or an absence of at least one of a file identifier or a life cycle identifier, a point of sale transaction status, a final authorization indicator, a transaction amount, an original transaction amount associated with an authorization, a message reversal indicator, or an original first presentment.

10. A method, comprising:
receiving, by a computing system, a first network message that is associated with a first network message flow of a first transaction and that includes first information, wherein the first information includes a first identifier;
determining, by the computing system using derivation logic and at least a portion of the first information, a first network message state of the first network message;
routing, by the computing system, the first network message to a destination computing device; and
storing, by the computing system, a first record that includes the first identifier, the first network message state, and at least a portion of the first information in a storage device.

11. The method of claim 10, further comprising:
generating and associating a first life cycle identifier to the first identifier, wherein determining, using the derivation logic and the at least a portion of the first information, the first network message state of the first network message is based on a presence or absence of the first life cycle identifier, and wherein the first life cycle identifier identifies the first transaction across the first network message flow and at least one second network message flow.

12. The method of claim 10, further comprising:
receiving a second network message that is associated with the first network message flow and that includes second information;
determining, using the derivation logic and at least a portion of the second information, a second network message state of the second network message, wherein the second network message state is different than the first network message state;
routing the second network message to a destination computing device; and
updating the first record with the second network message state.

13. The method of claim 10, further comprising:
determining, based on at least a portion of the first information, a total authorized amount and a total cleared amount of the first transaction; and
storing the total authorized amount and the total cleared amount in the first record.

14. The method of claim 10, further comprising:
injecting a first life cycle identifier in the first network message or any second network message that is generated based on the first network message.

15. The method of claim 10, wherein the first network message is an authorization request message that follows an ISO 8583 standard, and wherein the first network message flow is an authorization message flow.

16. The method of claim 10, further comprising:
receiving, from a user device via an application programming interface (API), a request for a network message state of the first transaction, wherein the request includes the first identifier;
retrieving, using the first identifier, the first network message state from the first record; and
providing the first network message state to the user device for display through a user interface.

17. The method of claim 10, wherein the first information includes a message type of the first network message, and wherein the at least a portion of the first information, used by the derivation logic to determine the first network message state of the first transaction, includes the message type.

18. The method of claim 10, wherein the at least a portion of the first information that is used by the derivation logic to determine the first network message state of the first transaction includes at least two of a message type of the first network message, a presence or an absence of at least one of a file identifier or a life cycle identifier, a point of sale transaction status, a final authorization indicator, a transaction amount, an original transaction amount associated with an authorization, a message reversal indicator, or an original first presentment.

19. A tangible, non-transitory, machine-readable medium storing instructions that when executed by one or more processors effectuate operations comprising:
receiving, by a computing system, a first network message that is associated with a first network message flow of a first transaction and that includes first information, wherein the first information includes a first identifier;
determining, by the computing system using derivation logic and at least a portion of the first information, a first network message state of the first network message;
routing, by the computing system, the first network message to a destination computing device; and
storing, by the computing system, a first record that includes the first identifier, the first network message state, and at least a portion of the first information in a storage device.

20. The tangible, non-transitory, machine-readable medium of claim 19, wherein the operations further comprise:
generating and associating a first life cycle identifier to the first identifier, wherein determining, using the derivation logic and the at least a portion of the first information, the first network message state of the first network message is based on a presence or absence of the first life cycle identifier, and wherein the first life cycle identifier identifies the first transaction across the first network message flow and at least one second network message flow.
